(19) United States
(12) Patent Application Publication
(10) Pub. No.: US 2025/0189463 A1
(43) Pub. Date: Jun. 12, 2025

(54) METHOD FOR SCANNING A COMPONENT

(71) Applicant: ROLLS-ROYCE plc, London (GB)

(72) Inventor: Akhil MULLOTH, Derby (GB)

(73) Assignee: ROLLS-ROYCE plc, London (GB)

(21) Appl. No.: 18/948,019

(22) Filed: Nov. 14, 2024

(30) Foreign Application Priority Data
Dec. 11, 2023 (GB) 2318829.5

(51) Int. Cl. G01N 23/046; G01N 1/30

(52) U.S. Cl. CPC G01N 23/046; G01N 1/30; G01N 2223/63

(57) ABSTRACT

A method for scanning a component includes applying a contrast agent to one or more regions of interest of the component. The method further includes providing a computed tomography scanner including an x-ray source and a detector. The method further includes placing the component between the x-ray source and the detector. The method further includes generating, via the x-ray source, an x-ray cone beam or fan beam that passes through the component. The method further includes receiving the x-ray cone beam or fan beam at the detector and generating an x-ray image of the component.

### FIELD OF THE DISCLOSURE

The present disclosure relates to scanning a component, and in particular, to a method for scanning a component.

### CROSS-REFERENCE TO RELATED APPLICATIONS

This specification is based upon and claims the benefit of priority from United Kingdom patent application number GB 2318829.5 filed on Dec. 11, 2023, the entire contents of which is incorporated herein by reference.

### BACKGROUND

X-ray scans such as computed tomography (CT) scans are conventionally used in industry for detecting defects such as voids, cracks, and inclusions, based on differences in X-ray absorption in these regions. CT techniques can also be used for investigative work on subjects such as aerofoil blades, and in particular, turbine blades of gas turbine engines. Generally, during a CT scan, x-ray beams that are generated by an x-ray source penetrate the subject to be scanned. The x-ray beam, after being attenuated by different densities of material within the subject, impinges upon an array of radiation detectors. The array of radiation detectors produces electrical signals indicative of the attenuated x-ray beam, thereby generating an x-ray image.

A three-dimensional CT scan creates a scan of the entire scan volume. A component (i.e., object of interest) is separated from a background by surface segmentation. Conventionally, thresholding algorithms mathematically fit a region of interest of the component to the scan. The accuracy of the thresholding step determines dimensional accuracy of the scan data, especially flatness or curvature of the region of interest. For calibration of CT parameters, reference data is required which is usually generated using an independent scanning method. Conventionally, for example, reference data is extracted using an alternative measurement method such as coordinate measurement, while cutting the component open to reveal non-line of sight surfaces or regions of interest.

Conventional algorithms for calibrating CT parameters involve a laborious task which depends on a material of the component, a geometry of the component, and other variables. Thus, conventional algorithms may not achieve the right threshold parameters to get accurate dimensional measurements of the scan data. Moreover, for components with intricate or delicate internal features, destructive techniques such as cutting the component open to use line of sight measurement methods to generate reference data may not be a feasible solution.

### SUMMARY OF THE DISCLOSURE

According to a first aspect, a method for scanning a component is provided. The method includes applying a contrast agent to one or more regions of interest of the component. A material of the contrast agent has a mass attenuation coefficient that is greater than a mass attenuation coefficient of a material of the component, thereby providing a contrast between the one or more regions of interest of the component and a rest of the component. The method includes providing a computed tomography (CT) scanner. The CT scanner includes an x-ray source and a detector. The method further includes placing the component between the x-ray source and the detector after the application of the contrast agent to the one or more regions of interest of the component. The method further includes generating, via the x-ray source, an x-ray cone beam or fan beam that passes through the component. The method further includes receiving the x-ray cone beam or fan beam at the detector. The detector is configured to generate an x-ray signal in response to receiving the x-ray cone beam or fan beam. The method further includes generating an x-ray image of the component based on the x-ray signal. In an application, the method of the present disclosure may also be used for scanning two or more components simultaneously.

As the mass attenuation coefficient of the material of the contrast agent is greater than the mass attenuation coefficient of the material of the component, the one or more regions of interest may be isolated with a desirable accuracy. For example, in some applications, the one or more regions of interest may be isolated with an accuracy of about one voxel without any need of conventional thresholding algorithms. The application of the contrast agent of such mass attenuation coefficient to the one or more regions of interest of the component may lead to enhancement of detectability of the one or more regions of interest of the component. Enhancement of detectability of the one or more regions of interest of the component may further lead to improved dimensional accuracy of the scan data, especially flatness or curvature of the one or more regions of interest. Improved dimensional accuracy of the scan data may enable accurate detection and inspection of small cracks, voids, or other features in the one or more regions of interest of the component.

In an application, applying the contrast agent to the one or more regions of interest of the component may lead to narrowing a transition zone between the one or more regions of interest of the component and the background to a few voxels wide (e.g., three vowels or lower). In an application, applying the contrast agent to the one or more regions of interest of the component may lead to narrowing the transition zone between the one or more regions of interest of the component and the background to about one voxel wide. Therefore, as compared to conventional techniques for detection or investigation of a surface, the method of the present disclosure may provide an improved technique for enhancement of detectability of the one or more regions of interest of the component without using any thresholding algorithm.

In some embodiments, the method further includes generating a greyscale plot of the x-ray image. The method further includes detecting one or more peaks in the greyscale plot corresponding to the one or more regions of interest of the component that are applied with the contrast agent. The one or more peaks in the greyscale plot denote the corresponding one or more regions of interest of the component. In this way, the one of more regions of interest of the component may be easily isolated or detected with the desirable accuracy based on location of the one or more peaks in the greyscale plot of the x-ray image.

In some embodiments, the method further includes determining one or more surface defects of the component based on the one or more peaks. As the one or more peaks enhance the detectability of the one of more regions of interest of the component, the one or more surface defects associated with the one or more regions of interest of the component may be clearly highlighted and investigated in the x-ray image of the component.

In some embodiments, the method further includes determining one or more edges of the component adjacent to a background of the component based on the one or more peaks. In applications where the regions of interest include the edges of the component, the method of the present disclosure may determine the one or more edges of the component with a desirable accuracy based on the one or more peaks. In other words, the method of the present disclosure may provide a contrast between the one or more edges of the component and the background of the component, and the one or more edges of the component can be determined based on the one or more peaks in the greyscale plot of the x-ray image.

In some embodiments, the one or more edges include at least two peaks. The method further includes determining a reference dimension of the component based on a distance between the two peaks, e.g. to optimise or calibrate dimensional accuracy of parts without coating on or as a way of directly extracting measurements. This reference dimension may be used for calibration of CT parameters. Therefore, the method of the present disclosure determines the reference dimension of the component with ease in comparison to conventional techniques of generating the reference dimension, such as coordinate measurement, or line of sight measurement techniques.

In some embodiments, the method further includes aligning the one or more peaks corresponding to the one or more regions of interest of the component with a reference geometry in order to perform a datum alignment of the x-ray image. Therefore, by applying the contrast agent to the one or more regions of interest of the component, the one or more regions of interest of the component may act as reference points. This allows specific measurements to be taken from such reference points. In applications where scan quality in areas where datum reference points are located may not be sufficient for the purpose, the method of the present disclosure may be used to mark the datum points and help locate the datum points in 3D CT scans for use as reference points for alignment. Hence, datum alignment of the x-ray image can be performed by using the method of the present disclosure rather than using a conventional fixture to hold the component.

In some embodiments, applying the contrast agent further includes infusing the contrast agent into one or more pores of the component, optionally under pressure. In this way, the method of the present disclosure may enhance the contrast of a portion of the component with the one or more pores. In conventional scanning techniques, such portion of the component with the one or more pores was difficult to investigate due to noisy transition zone or due to smaller size of the portion with the one or more pores relative to a rest of the component.

In some embodiments, applying the contrast agent further includes lowering a temperature of the component to solidify the contrast agent after infusion. Solidification of the contrast agent after infusion into the one or more pores of the component may enhance detectability of the portion of the component with the one or more pores.

In some embodiments, applying the contrast agent further includes coating the one or more regions of interest of the component with the contrast agent. The one or more regions of interest of the component are coated with the contrast agent prior to generation of x-ray cone beam or fan beam that passes through the component.

In some embodiments, the coating process is one of direct coating, chemical vapor deposition, physical vapor deposition, electroplating, electroplating and selective etching, multi-material additive layer manufacturing, and powder coating. The coating process is selected based on the material of the contrast agent, the material of the component, a desirable thickness of the coating, environmental factors, and so on.

In some embodiments, the contrast agent includes mercury, lead, platinum or an alloy thereof. Lead has the greatest mass attenuation coefficient out of these materials. Selection of the material of the contrast agent is based on desirable ratio of the mass attenuation coefficient of the material of the contrast agent to the mass attenuation coefficient of the material of the component. However, any material having the mass attenuation coefficient greater than the mass attenuation coefficient of the material of the component may be used by the method of the present disclosure.

In some embodiments, the contrast agent includes a resin embedded with a plurality of nanoparticles. The nanoparticles may be of lead or platinum, or of any material which has greater mass attenuation coefficient than the mass attenuation coefficient of the material of the component.

In some embodiments, applying the contrast agent further includes coating the one or more regions of interest of the component with the resin. Applying the contrast agent further includes curing the resin after coating by at least one of lowering a temperature and exposure to light. Curing or solidification of the resin after coating may enhance the detectability of the one or more regions of interest of the component.

In some embodiments, the x-ray image includes a plurality of voxels. Each voxel from the plurality of voxels has a voxel size. A thickness of the contrast agent on the one or more regions of interest of the component is equal to or less than the voxel size. In an application where the mass attenuation coefficient of the contrast agent is ten times the mass attenuation coefficient of the material of the component, the thickness of the contrast agent on the one or more regions of interest of the component can be up to one tenth of the voxel size. Similarly, in an application where the mass attenuation coefficient of the contrast agent is five times the mass attenuation coefficient of the material of the component, the thickness of the contrast agent on the one or more regions of interest of the component can be up to one fifth of the voxel size. In an application where the mass attenuation coefficient of the contrast agent is comparable to the mass attenuation coefficient of the material of the component, the thickness of the contrast agent on the one or more regions of interest of the component can be close to the voxel size. In general, if n=the mass attenuation coefficient of the contrast agent/the mas attenuation coefficient of the material of the component, then the thickness of the contrast agent on the one or more regions of interest of the component can be greater than or equal to 1/n of the voxel size and less than or equal to (1/n+ 1/10) of the voxel size (i.e., additional limit of 1/10 of the voxel size). In some other embodiments, the thickness of the contrast agent on the one or more regions of interest of the component may be greater than the voxel size. However, the thickness of the contrast agent on the one or more regions of interest of the component may be at most five times the voxel size.

In some embodiments, the mass attenuation coefficient of the material of the contrast agent is at least twice the mass attenuation coefficient of the material of the component. When the mass attenuation coefficient of the material of the contrast agent is at least twice the mass attenuation coefficient of the material of the component, the thickness of the contrast agent on the one or more regions of interest of the component may be half of the voxel size.

In some embodiments, component is metallic. The metallic component may be an industrial part. The component may be a metal alloy part. The metallic component may be a part used in aerospace industry.

In some embodiments, the component is a turbine blade of a gas turbine engine. Therefore, the method of the present disclosure may be used for scanning and inspection of the turbine blade for any damage or wear, or for checking the integrity of the turbine blade.

As noted elsewhere herein, the present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed). The gearbox may be a reduction gearbox (in that the output to the fan is a lower rotational rate than the input from the core shaft). Any type of gearbox may be used.

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

In any gas turbine engine as described and/or claimed herein, a combustor may be provided axially downstream of the fan and compressor(s). For example, the combustor may be directly downstream of (for example at the exit of) the second compressor, where a second compressor is provided. By way of further example, the flow at the exit to the combustor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. The bypass duct may be substantially annular. The bypass duct may be radially outside the engine core. The radially outer surface of the bypass duct may be defined by a nacelle and/or a fan case.

Specific thrust of an engine may be defined as the net thrust of the engine divided by the total mass flow through the engine. At cruise conditions, the specific thrust of an engine described and/or claimed herein may be less than (or in the order of) any of the following: 110 Nkg-1 s, 105 Nkg-1 s, 100 Nkg-1 s, 95 Nkg-1 s, 90 Nkg-1 s, 85 Nkg-1 s or 80 Nkg-1 s. The specific thrust may be in an inclusive range bounded by any two of the values in the previous sentence (i.e., the values may form upper or lower bounds), for example in the range of from 80 Nkg-1 s to 100 Nkg-1 s, or 85 Nkg-1 s to 95 Nkg-1 s. Such engines may be particularly efficient in comparison with conventional gas turbine engines.

A fan blade and/or aerofoil portion of a fan blade described and/or claimed herein may be manufactured from any suitable material or combination of materials. For example, at least a part of the fan blade and/or aerofoil may be manufactured at least in part from a composite, for example a metal matrix composite and/or an organic matrix composite, such as carbon fibre. The fan of a gas turbine as described and/or claimed herein may have any desired number of fan blades, for example 14, 16, 18, 20, 22, 24 or 26 fan blades.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only, with reference to the Figures, in which:

FIG. 1 is a schematic sectional side view of a gas turbine engine;

FIG. 2 is a schematic view of a system for scanning a component;

FIG. 3 is a schematic view of the component shown in FIG. 2 before scanning the component;

FIG. 4 is an x-ray image of a portion of the component of FIG. 3 generated by the system of FIG. 2;

FIG. 5 is a representation of voxels within a scan volume of the x-ray image of the component;

FIG. 6 is a greyscale plot of the x-ray image of FIG. 4;

FIG. 7 is an x-ray image of a component generated by the system of FIG. 2;

FIG. 8 is a greyscale plot of the x-ray image of FIG. 7;

FIG. 9 is an x-ray image of a component generated by the system of FIG. 2;

FIG. 10 is an x-ray image of a component of the gas turbine engine of FIG. 1 generated by the system of FIG. 2; and

FIG. 11 is a flowchart for a method of the present disclosure for scanning a component.

### DETAILED DESCRIPTION

Aspects and embodiments of the present disclosure will now be discussed with reference to the accompanying Figures. Further aspects and embodiments will be apparent to those skilled in the art.

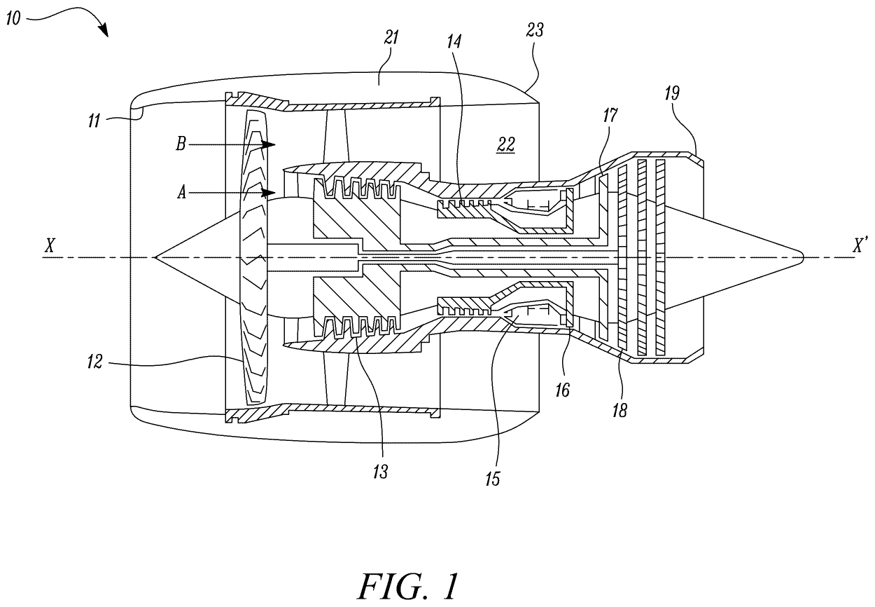

FIG. 1 shows a schematic sectional side view of a gas turbine engine 10 having a principal rotational axis X-X′. The gas turbine engine 10 includes, in axial flow series, an air intake 11, a compressive fan 12 (which may also be referred to as a low-pressure compressor), an intermediate pressure compressor 13, a high-pressure compressor 14, a combustion equipment 15, a high-pressure turbine 16, an intermediate pressure turbine 17, a low-pressure turbine 18, and a core exhaust nozzle 19. A nacelle 21 generally surrounds the gas turbine engine 10 and defines the air intake 11, a bypass duct 22, and a bypass exhaust nozzle 23.

The gas turbine engine 10 works in a conventional manner so that the air entering the air intake 11 is accelerated by the compressive fan 12 to produce two air flows: a first air flow A into the intermediate pressure compressor 13 and a second air flow B which passes through the bypass duct 22 to provide a propulsive thrust. The intermediate pressure compressor 13 compresses the first air flow A directed into it before delivering that air to the high-pressure compressor 14 where further compression takes place.

The compressed air exhausted from the high-pressure compressor 14 is directed into the combustion equipment 15 where it is mixed with fuel and the mixture combusted. The resulting hot combustion products then expand through, and thereby drive the high, intermediate, and low-pressure turbines 16, 17, 18 before being exhausted through the core exhaust nozzle 19 to provide additional propulsive thrust. The high, intermediate, and low-pressure turbines respectively drive the high and intermediate pressure compressors, 14, 13, and the compressive fan 12 by suitable interconnecting shafts.

In some embodiments, the gas turbine engine 10 is used in an aircraft. In some embodiments, the gas turbine engine 10 is an ultra-high bypass ratio engine (UHBPR). In addition, the present invention is equally applicable to aero gas turbine engines, marine gas turbine engines and land-based gas turbine engines.

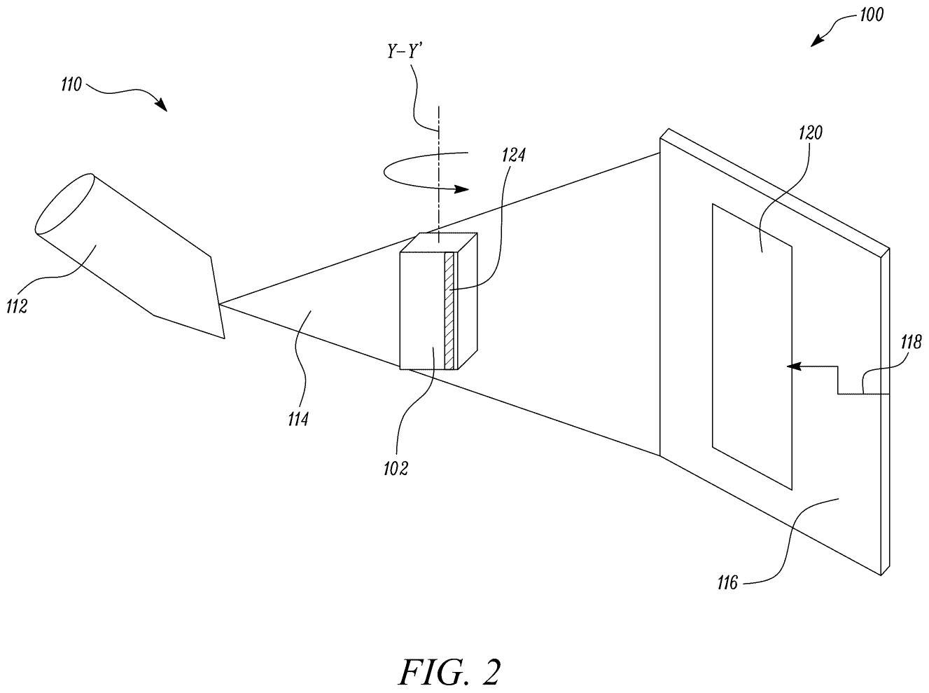

FIG. 2 is a schematic view of a system 100 for scanning a component 102. In some embodiments, the component 102 is a part of the gas turbine engine 10 (shown in FIG. 1). In some embodiments, the component 102 is metallic. The component 102 is shown schematically in FIG. 2 for the purpose of illustration. Other shapes for the component 102 are foreseeable and could be used. In the illustrated embodiment of FIG. 2, only one component 102 is shown. However, the system 100 may be used for scanning two or more components together.

The system 100 includes a computed tomography (CT) scanner 110. In some embodiments, the CT scanner 110 may allow the component 102 to be scanned and a density of materials contained therein to be determined for various diagnostic and evaluation purposes. In general, CT scanning, e.g. 3DCT scanning or 2DCT slack scanning, generates a three-dimensional (3D) image of a test specimen by utilizing digital geometry processing of a series of two-dimensional (2D) x-ray images taken around a single axis of rotation.

The CT scanner 110 includes an x-ray source 112 configured to generate an x-ray cone beam 114 or fan beam that passes through the component 102. In some embodiments, the x-ray cone beam 114 or fan beam may represent an energy beam within the x-ray region of the electromagnetic spectrum, in fact any in the EM spectrum that can penetrate or be transmitted through a material after attenuation such as gamma rays. In some embodiments, the x-ray source 112 may include, for example, an x-ray tube (not shown) that produces x-rays by accelerating electrons through an electric field. The x-ray tube typically includes an electron source (or cathode) for generating electrons, and an x-ray target (or anode) containing x-ray emissive material adapted to emit the x-rays in response to incident electrons that have been accelerated by an accelerating electric field.

In some embodiments, the electric field may be established by means of a voltage provided to the x-ray source 112 by a high voltage power supply (not shown). The emitted x-rays may be further processed to generate the x-ray cone beam 114 or fan beam. The CT scanner 110 further includes a detector 116 configured to receive the x-ray cone beam 114 or fan beam and generate an x-ray signal 118 in response to receiving the x-ray cone beam 114 or fan beam. In some embodiments, the detector 116 may be an energy differentiating detector.

in some embodiments, the detector 116 receives the x-ray cone beam 114 or fan beam that is attenuated after passing through the component 102. In some embodiments, the detector 116 generates an electrical signal (i.e., the x-ray signal 118) representing an intensity of the impinging x-ray cone beam 114 or fan beam, and hence, the attenuated x-ray cone beam 114 or fan beam. Output from the detector 116 may then be reconstructed and processed in a manner known per se to produce a two-dimensional (2D) image in the form of a slice taken through the component 102. Thus, the detector 116 generates an x-ray image 120 (scan view or slice) of the component 102 based on the x-ray signal 118.

By adjusting relative positions of the component 102 and the x-ray cone beam 114 or fan beam and repeating the process, a plurality of 2D images of the component 102 may be taken at different angular positions about an axis of rotation Y-Y′.

In applications where the system 100 may be used for scanning a plurality of components simultaneously, the plurality of components may be oriented to provide rotational symmetry about the axis of rotation Y-Y′, although one part or a plurality of parts being offset relative to the axis of rotation would also be acceptable. For example, the plurality of components may be positioned along vertices of a regular geometric figure. The plurality of components may have different shapes or sizes, and still possess a rotational symmetry about the axis of rotation Y-Y′ in terms of positioning. It should be noted that other alternative energy forms, such as gamma rays, or any other energy beam suitable for scanning may also be used instead of x-rays for scanning the component 102.

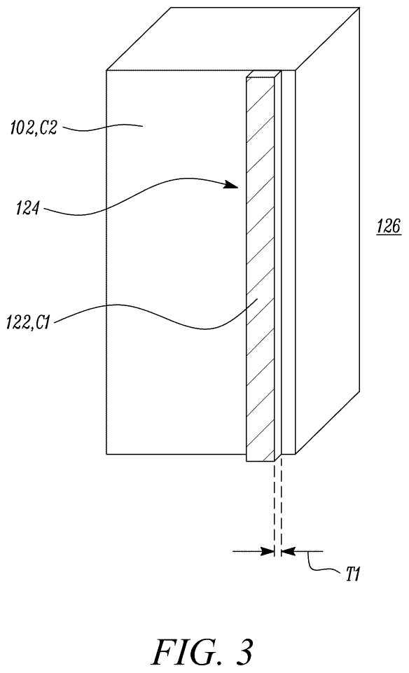

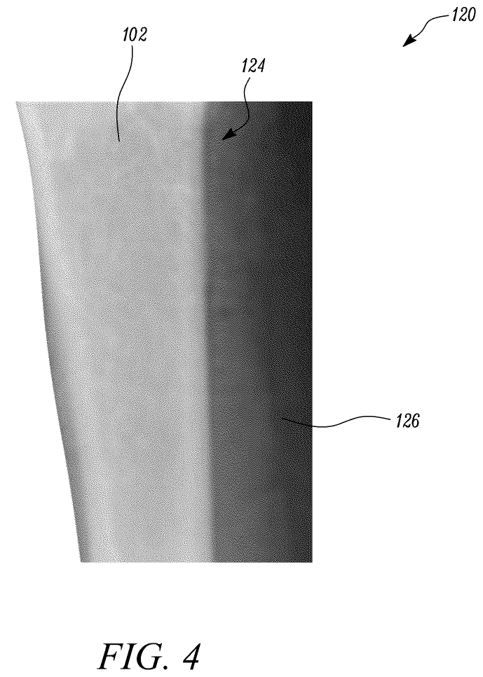

FIG. 3 is a schematic view of the component 102 before scanning the component 102, according to an embodiment of the present disclosure. It should be noted that the component 102 shown in FIG. 3 is an exemplary component for illustrative and descriptive purposes. FIG. 4 is the x-ray image 120 of a portion of the component 102 of FIG. 3 generated by the system 100, according to an embodiment of the present disclosure.

Referring to FIGS. 2 to 4, a contrast agent 122 (shown schematically in FIG. 3) is applied to one or more regions of interest 124 of the component 102 before scanning the component 102. The one or more regions of interest 124 may include locations of the component 102 which are susceptible to higher stresses and higher loads. For example, the one or more regions of interest 124 may include areas that are prone to surface defects, cracks, irregularities, etc.

A material of the contrast agent 122 has a mass attenuation coefficient C1 that is greater than a mass attenuation coefficient C2 of a material of the component 102. The degree to which a given material blocks x-ray transmission, is measured by an attenuation coefficient, which accounts for both energy absorption and the scattering of photons. Often, mass attenuation coefficients, which measure attenuation per unit mass, are utilized, because they do not change with the density of the material. As the material of the contrast agent 122 has the mass attenuation coefficient C1 greater than the mass attenuation coefficient C2 of the material of the component 102, a contrast is provided between the one or more regions of interest 124 of the component 102 and a rest of the component 102. This makes it possible to acquire an accurate imaging data of the one or more regions of interest 124 of the component 102.

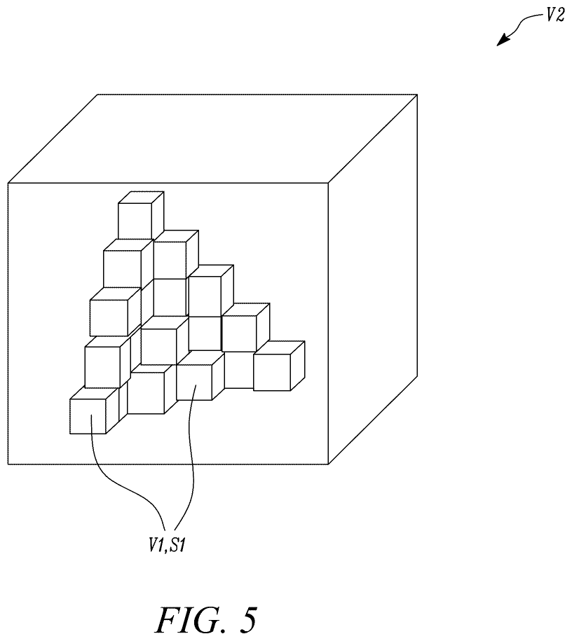

FIG. 5 is a representation of voxels V1 within a scan volume V2 of the x-ray image 120 of the component 102. As used herein, the term “voxel” refers to a unit element representing a volumetric pixel achieved through imaging information acquired through use of an imaging system (i.e., the system 100 of FIG. 2). In other words, voxel represents a volumetric pixel depicting a value in the three-dimensional space, corresponding to a pixel for a given slice thickness.

Referring to FIGS. 2 to 5, in some embodiments, the x-ray image 120 includes a plurality of voxels V1 (shown in FIG. 5). Each voxel V1 from the plurality of voxels V1 has a voxel size S1. The voxel size S1 may be chosen to be equal to the spacing between two voxels V1 from the plurality of voxels V1. In some embodiments, a thickness T1 (shown in FIG. 3) of the contrast agent 122 on the one or more regions of interest 124 of the component 102 is equal to or less than the voxel size S1. The thickness T1 of the contrast agent 122 may be selected based on a ratio of the mass attenuation coefficient C1 of the contrast agent 122 to the mass attenuation coefficient C2 of the material of the component 102.

In an application where the mass attenuation coefficient C1 of the contrast agent 122 is ten times the mass attenuation coefficient C2 of the material of the component 102, the thickness T1 of the contrast agent 122 on the one or more regions of interest 124 of the component 102 can be up to one tenth of the voxel size S1. Similarly, in an application where the mass attenuation coefficient C1 of the contrast agent 122 is five times the mass attenuation coefficient C2 of the material of the component 102, the thickness T1 of the contrast agent 122 on the one or more regions of interest 124 of the component 102 can be up to one fifth of the voxel size S1. In an application where the mass attenuation coefficient C1 of the contrast agent 122 is comparable to the mass attenuation coefficient C2 of the material of the component 102, the thickness T1 of the contrast agent 122 on the one or more regions of interest 124 of the component 102 can be close to the voxel size S1.

In general, if n=C1/C2, then S1/n≤T1≤(1/n+ 1/10)*S1 (i.e., additional limit of 1/10 of the voxel size).

In some embodiments, the thickness T1 of the contrast agent 122 on the one or more regions of interest 124 of the component 102 may be greater than the voxel size S1.

In some embodiments, the thickness T1 of the contrast agent 122 on the one or more regions of interest 124 of the component 102 may be at most five times the voxel size S1.

In some embodiments, the thickness T1 of the contrast agent 122 on the one or more regions of interest 124 of the component 102 may be more than five times the voxel size S1, e.g. in small cracks the coating on either side may touch each other to have a total thickness that is more than five times the voxel size S1.

In some embodiments, the mass attenuation coefficient C1 of the material of the contrast agent 122 is at least twice the mass attenuation coefficient C2 of the material of the component 102. When the mass attenuation coefficient C1 of the material of the contrast agent 122 is at least twice the mass attenuation coefficient C2 of the material of the component 102, the thickness T1 of the contrast agent 122 on the one or more regions of interest 124 of the component 102 may be half of the voxel size S1.

As the mass attenuation coefficient C1 of the material of the contrast agent 122 is greater than the mass attenuation coefficient C2 of the material of the component 102, the one or more regions of interest 124 may be isolated with a desirable accuracy. For example, in some applications, the one or more regions of interest 124 may be isolated with an accuracy of about one voxel without any need of conventional thresholding algorithms.

The application of the contrast agent 122 of such mass attenuation coefficient C1 to the one or more regions of interest 124 of the component 102 may lead to enhancement of detectability of the one or more regions of interest 124 of the component 102.

Enhancement of detectability of the one or more regions of interest 124 of the component 102 may further lead to improved dimensional accuracy of the scan data, especially flatness or curvature of the one or more regions of interest 124. Improved dimensional accuracy of the scan data may enable accurate detection and inspection of small cracks, voids, or other features in the one or more regions of interest 124 of the component 102.

In an application, application of the contrast agent 122 to the one or more regions of interest 124 of the component 102 may lead to narrowing a transition zone between the one or more regions of interest 124 of the component 102 and a background 126 (also shown in FIG. 3) to a few voxels wide (e.g., three vowels or lower). In an application, application of the contrast agent 122 to the one or more regions of interest 124 of the component 102 may lead to narrowing the transition zone Z1 between the one or more regions of interest 124 of the component 102 and the background 126 to about one voxel wide. Therefore, as compared to conventional techniques for detection or investigation of a surface, the present disclosure may provide an improved technique for enhancement of detectability of the one or more regions of interest 124 of the component 102 without using any thresholding algorithm. These data may then act as reference data for calibrating the scan parameters and for determining the dimensional accuracy and repeatability of measurements extracted from scans without coating on the part.

In some embodiments, the contrast agent 122 includes mercury, lead, platinum or an alloy thereof. Lead has the greatest mass attenuation coefficient out of these materials.

Selection of the material of the contrast agent 122 is based on desirable ratio of the mass attenuation coefficient C1 of the material of the contrast agent 122 to the mass attenuation coefficient C2 of the material of the component 102. However, any material having the mass attenuation coefficient greater than the mass attenuation coefficient C2 of the material of the component 102 may be applied to the one or more regions of interest 124 of the component 102.

In some embodiments, the contrast agent 122 is applied to the one or more regions of interest 124 of the component 102 by coating the one or more regions of interest 124 of the component 102 with the contrast agent 122. The one or more regions of interest 124 of the component 102 are coated with the contrast agent 122 prior to generation of the x-ray cone beam 114 or fan beam that passes through the component 102.

In some embodiments, the coating process is one of direct coating, chemical vapor deposition, physical vapor deposition, electroplating, electroplating and selective etching, multi-material additive layer manufacturing, and powder coating. The coating process is selected based on the material of the contrast agent, the material of the component 102, a desirable thickness of the coating, environmental factors, and so on.

In some embodiments, the contrast agent 122 includes a resin embedded with a plurality of nanoparticles. The nanoparticles may be of lead or platinum, or of any material which has greater mass attenuation coefficient than the mass attenuation coefficient C2 of the material of the component 102. For such embodiments, the one or more regions of interest 124 of the component 102 are coated with the resin. Further, after coating the resin, the resin is cured by at least one of lowering a temperature, increasing a temperature and exposure to light. Curing or solidification of the resin after coating may enhance the detectability of the one or more regions of interest 124 of the component 102.

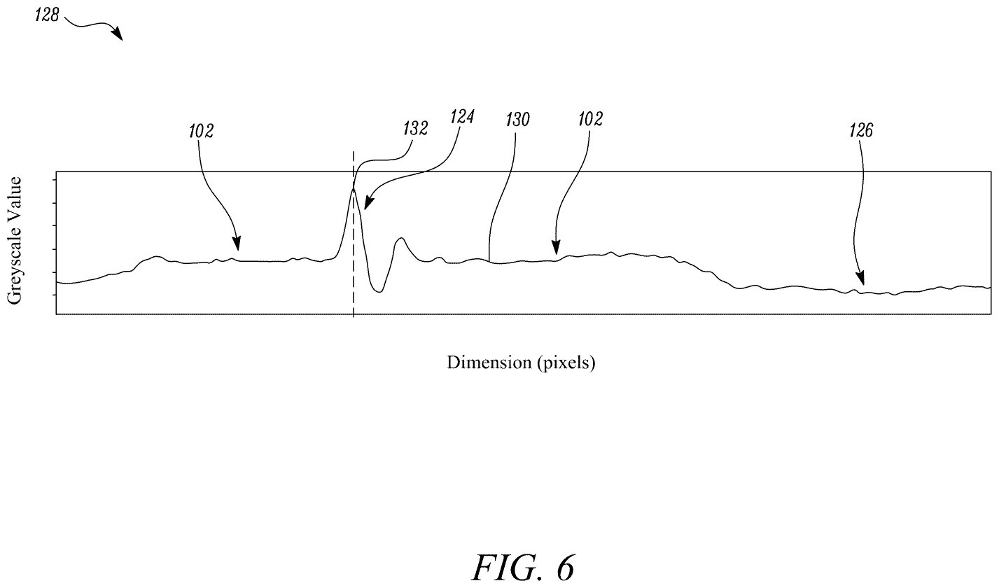

FIG. 6 is a greyscale plot 128 of the x-ray image 120 of FIG. 4, according to an embodiment of the present disclosure. The greyscale plot 128 shows a one-dimensional plot of the greyscale values along a dimension of the component 102. The dimension of the component 102 is shown in the abscissa in arbitrary units and the greyscale values are shown in the ordinate. Higher greyscale value denotes more shade of white. The greyscale plot 128 shows a curve 130. In the illustrated greyscale plot 128, the one or more regions of interest 124 include only a single region of interest 124 for illustrative purposes.

The curve 130 includes a peak 132 that corresponds to the region of interest 124 of the component 102 that is applied with the contrast agent 122. In other words, by applying the contrast agent 122 to the region of interest 124 of the component 102, the peak 132 in the greyscale plot 128 can be detected that corresponds to the region of interest 124 of the component 102. In this way, the region of interest 124 of the component 102 may be easily isolated or detected with the desirable accuracy based on location of the peak 132 in the greyscale plot 128 of the x-ray image 120 of the component 102. Based on the peak 132, one or more surface defects associated with region of interest 124 of the component 102 may be clearly highlighted and investigated in the x-ray image 120 of the component 102. For example, when the contrast agent 122 is applied to the region of interest 124 of the component 102, the transition zone is about two times the voxel size S1. This means that the region of interest 124 can be easily identified and investigated in the x-ray image 120 of the component 102.

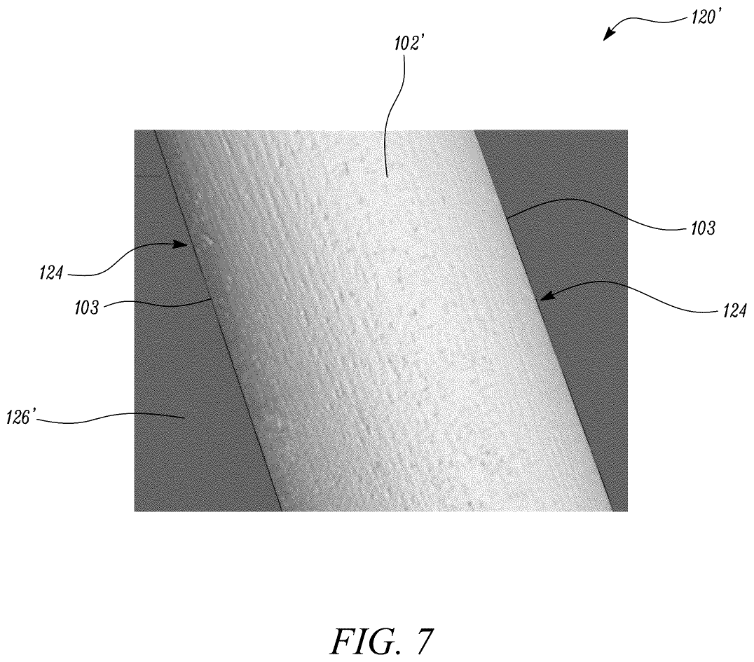

FIG. 7 is an x-ray image 120′ of a component 102′ generated by the system 100 of FIG. 1, according to an embodiment of the present disclosure. The contrast agent 122 (shown schematically in FIG. 3) of the thickness T1 is applied to one or more regions of interest 124 of the component 102′ before scanning the component 102′. In some embodiments, the component 102′ may be metallic. In some embodiments, the component 102′ may be a component of the gas turbine engine of FIG. 1.

In the component 102′, the one or more regions of interest 124 include one or more edges 103 of the component 102′ adjacent to a background 126′ of the component 102′. In the illustrated embodiment of FIG. 7, the one or more regions of interest 124 include two regions of interest 124. The two regions of interest 124 include two edges 103 of the component 102′.

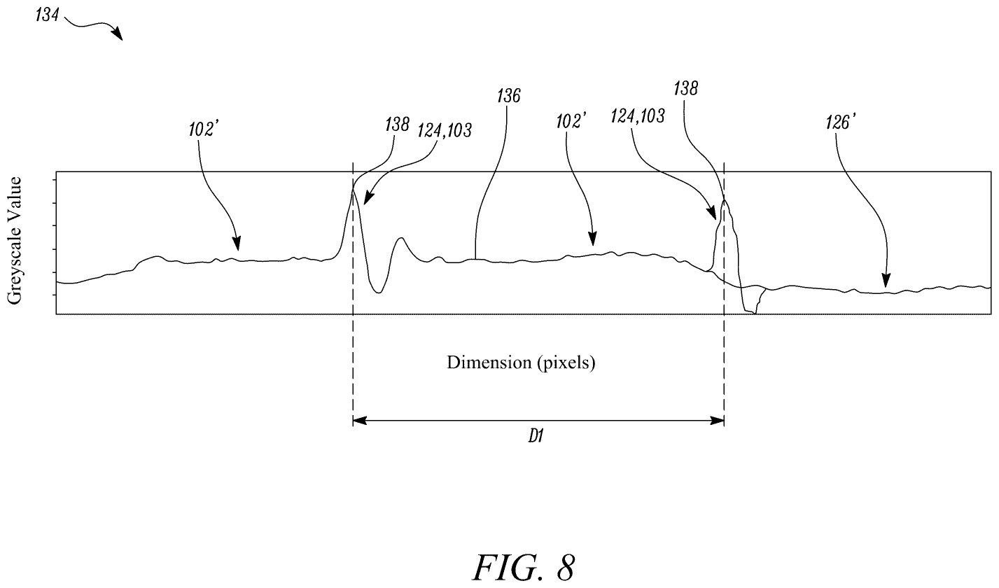

FIG. 8 is a greyscale plot 134 of the x-ray image 120′ of FIG. 7, according to an embodiment of the present disclosure. The greyscale plot 134 shows a one-dimensional plot of the greyscale values along a dimension of the component 102′. The dimension of the component 102′ is shown in the abscissa in arbitrary units and the greyscale values are shown in the ordinate. The greyscale plot 134 shows a curve 136.

The curve 136 includes two peaks 138 that correspond to the respective regions of interest 124 of the component 102′ that is applied with the contrast agent 122. In other words, by applying the contrast agent 122 to the regions of interest 124 of the component 102′, the peaks 138 in the greyscale plot 134 can be detected that corresponds to the respective regions of interest 124 of the component 102′. In this way, the regions of interest 124 of the component 102′ may be easily isolated or detected with the desirable accuracy based on location of the peaks 138 in the greyscale plot 134 of the x-ray image 120′ of the component 102′. Based on the peaks 138, surface defects associated with regions of interest 124 of the component 102′ may be clearly highlighted and investigated in the x-ray image 120′ of the component 102′. This means that the regions of interest 124 (i.e., the two edges 103) can be easily identified and investigated in the x-ray image 120′ of the component 102′.

Further, with reference to FIGS. 1, 7, and 8, the one or more edges 103 include at least two peaks 138. From the greyscale plot 134, a reference dimension of the component 102′ can be determined based on a distance D1 between the two peaks 138. This reference dimension may be used for calibration of CT parameters. In comparison to conventional techniques of generating the reference dimension, such as coordinate measurement, or line of sight measurement techniques, the reference dimension can be easily determined by the greyscale plot 134 based on the distance D1.

The one or more peaks 138 corresponding to the one or more regions of interest 124 of the component 102′ are aligned with a reference geometry in order to perform a datum alignment of the x-ray image 120′ shown in FIG. 7. Therefore, by applying the contrast agent 122 to the one or more regions of interest 124 of the component 102′, the one or more regions of interest 124 of the component 102′ may act as reference points. This allows specific measurements to be taken from such reference points. In applications where scan quality in areas where datum reference points are located may not be sufficient for the purpose, the one or more peaks 138 may be used to mark the datum points and help locate the datum points in 3D CT scans for use as reference points for alignment. Hence, datum alignment of the x-ray image 120′ can be performed based on the one or more peaks 138.

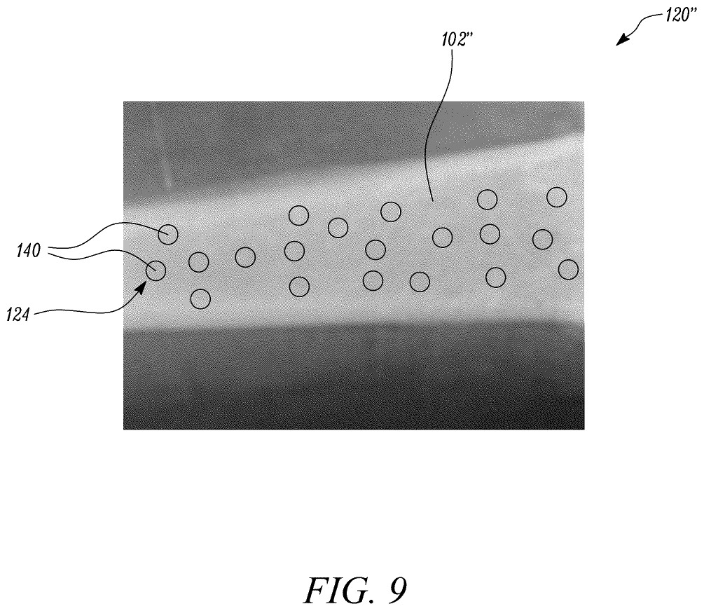

FIG. 9 is an x-ray image 120″ of a component 102″ generated by the system 100 of FIG. 1, according to an embodiment of the present disclosure. The contrast agent 122 (shown schematically in FIG. 3) of the thickness T1 is applied to one or more regions of interest 124 of the component 102″ before scanning the component 102″. The contrast agent may be applied directly or indirectly such as by encapsulating/sandwiching the high density material between thin films that can adhere to the surface. The adhesive film itself may have a higher mass attenuation relative to the part. In some embodiments, the component 102″ may be metallic. In some embodiments, the component 102″ may be a component of the gas turbine engine of FIG. 1.

The component 102″ is a porous component having one or more pores 140. In some embodiments, the contrast agent 122 is applied to the one or more regions of interest 124 of the component 102″ by infusing the contrast agent 122 into the one or more pores 140 of the component 102″. The infusion of the contrast agent 122 into the one or more pores 140 may enhance the contrast of that portion of the component 102″. In conventional scanning techniques, such portion of a component with one or more pores was difficult to investigate due to noisy transition zone or due to smaller size of the portion with the one or more pores relative to a rest of the component.

In some embodiments, a temperature of the component 102″ is lowered to solidify the contrast agent 122 after infusion. Pressure may be applied to enhance penetration of liquid contrast agent or resin into pores. Solidification of the contrast agent 122 after infusion into the one or more pores 140 of the component 102″ may enhance detectability of the portion of the component 102″ with the one or more pores 140. By generating a greyscale plot (not shown) for the x-ray image 120″, the one or more pores 140 of the component 102″ can be easily determined and investigated.

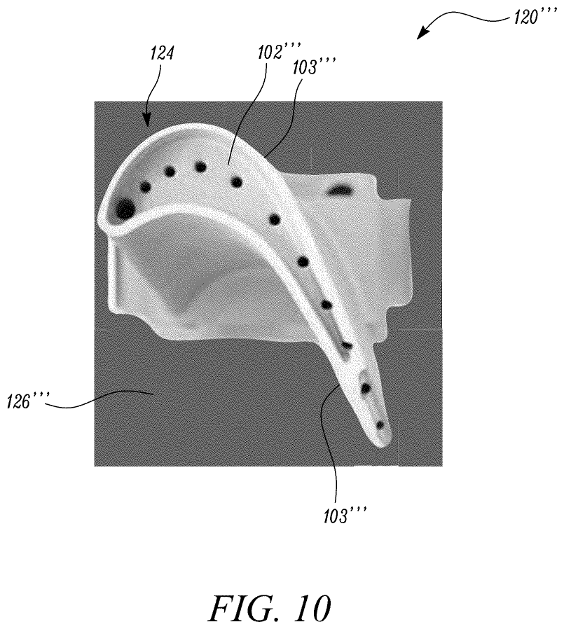

FIG. 10 is an x-ray image 120′″ of a component 102′″ of the gas turbine engine of FIG. 1 generated by the system 100 of FIG. 2, according to an embodiment of the present disclosure. The contrast agent 122 (shown schematically in FIG. 3) of the thickness T1 is applied to one or more regions of interest 124 of the component 102′″ before scanning the component 102′″. In the illustrated embodiment of FIG. 10, the component 102′″ is a turbine blade of the gas turbine engine 10 shown in FIG. 1. The turbine blade may be a part of the high, intermediate, and/or low-pressure turbines 16, 17, 18 (shown in FIG. 1). In the x-ray image 120′″, the one or more regions of interest 124 of the component 102′″ include one or more edges 103′″ of the component 102′″. By generating a greyscale plot (not shown) for the x-ray image 120′″, the one or more edges 103′″ of the component 102′″ adjacent to a background 126′″ of the component 102′″ can be easily determined.

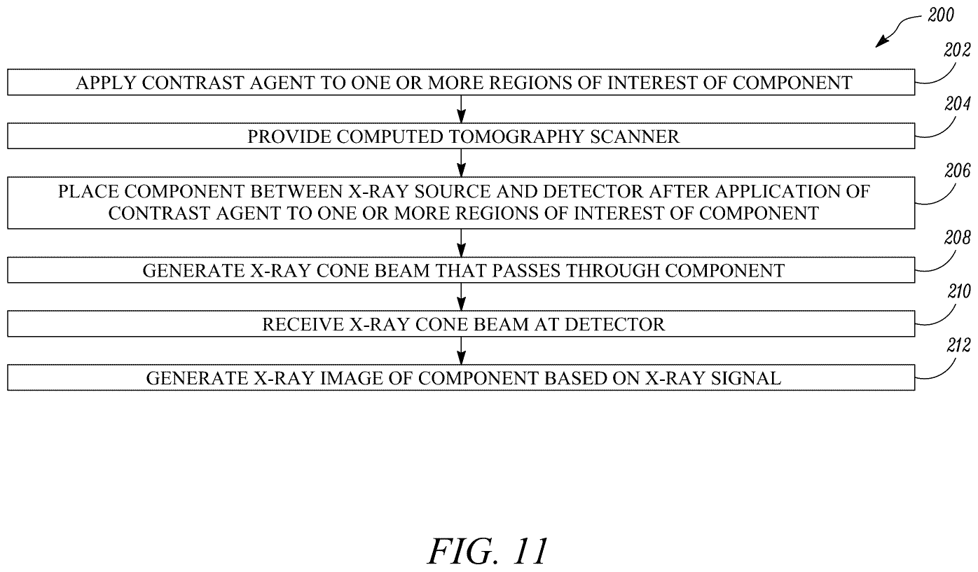

FIG. 11 is a flowchart for a method 200 for scanning the component 102 shown in FIG. 3, according to an embodiment of the present disclosure. The method 200 may be at least partly performed by the system 100 of FIG. 2. The method 200 may also be used scanning the component 102′ shown in FIG. 7, the component 102″ shown in FIG. 9, and the component 102′″ shown in FIG. 10.

Referring to FIGS. 2 to 11, at step 202, the method 200 includes applying the contrast agent 122 (shown schematically in FIG. 3) to the one or more regions of interest 124 of the component 102. In some embodiments, applying the contrast agent 122 further includes coating the one or more regions of interest 124 of the component 102 with the contrast agent 122. In some embodiments, applying the contrast agent 122 further includes coating the one or more regions of interest 124 of the component 102 with the contrast agent 122 by one of direct coating, chemical vapor deposition, physical vapor deposition, electroplating, electroplating and selective etching, multi-material additive layer manufacturing, and powder coating. In some embodiments, applying the contrast agent 122 further includes coating the one or more regions of interest 124 of the component 102 with the contrast agent 122 indirectly such as by encapsulating/sandwiching the high density material between thin films that can adhere to the surface. The adhesive film itself may have a higher mass attenuation relative to the part.

In some embodiments, applying the contrast agent 122 further includes coating the one or more regions of interest 124 of the component 102 with the resin embedded with a plurality of nanoparticles. In some embodiments, applying the contrast agent 122 further includes curing the resin after coating by at least one of lowering the temperature and exposure to light.

In some embodiments, applying the contrast agent 122 further includes infusing the contrast agent 122 into the one or more pores 140 of the component 102″ (shown in FIG. 9). In some embodiments, applying the contrast agent 122 further includes lowering the temperature of the component 102″ to solidify the contrast agent 122 after infusion.

At step 204, the method 200 includes providing the CT scanner 110 (shown in FIG. 2). At step 206, the method 200 includes placing the component 102 between the x-ray source 112 and the detector 116 (shown in FIG. 2) after the application of the contrast agent 122 to the one or more regions of interest 124 of the component 102. At step 208, the method 200 includes generating, via the x-ray source 112, the x-ray cone beam 114 or fan beam that passes through the component 102. At step 210, the method 200 includes receiving the x-ray cone beam 114 or fan beam at the detector 116. At step 212, the method 200 includes generating the x-ray image 120 of the component 102 based on the x-ray signal 118 (shown in FIG. 2).

In some embodiments, the method 200 further includes generating the greyscale plot 128 (shown in FIG. 6) of the x-ray image 120. The method 200 further includes detecting the one or more peaks 132 (shown in FIG. 6) in the greyscale plot 128 corresponding to the one or more regions of interest 124 of the component 102 that are applied with the contrast agent 122. In some embodiments, the method 200 further includes determining the one or more surface defects of the component 102 based on the one or more peaks 132.

In some embodiments, the method 200 further includes determining the one or more edges 103 (shown in FIG. 7) of the component 102′ adjacent to the background 126′ of the component 102′ based on the one or more peaks 138 (shown in FIG. 8). In some embodiments, the method 200 further includes determining the reference dimension of the component 102′ based on the distance D1 (shown in FIG. 8) between the two peaks 138. In some embodiments, the method 200 further includes aligning the one or more peaks 138 corresponding to the one or more regions of interest 124 of the component 102′ with the reference geometry in order to perform the datum alignment of the x-ray image 120′.

It will be understood that the invention is not limited to the embodiments above described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A method for scanning a component, the method comprising:
applying a contrast agent to one or more regions of interest of the component, wherein a material of the contrast agent has a mass attenuation coefficient that is greater than a mass attenuation coefficient of a material of the component thereby providing a contrast between the one or more regions of interest of the component and a rest of the component;
providing a computed tomography (CT) scanner, wherein the CT scanner comprises an x-ray source and a detector;
placing the component between the x-ray source and the detector after the application of the contrast agent to the one or more regions of interest of the component;
generating, via the x-ray source, an x-ray cone beam or fan beam that passes through the component;
receiving the x-ray cone beam or fan beam at the detector, wherein the detector is configured to generate an x-ray signal in response to receiving the x-ray cone beam or fan beam; and
generating an x-ray image of the component based on the x-ray signal.

2. The method of claim 1, further comprising:
generating a greyscale plot of the x-ray image; and
detecting one or more peaks in the greyscale plot corresponding to the one or more regions of interest of the component that are applied with the contrast agent.

3. The method of claim 2, further comprising determining one or more surface defects of the component based on the one or more peaks.

4. The method of claim 2, further comprising determining one or more edges of the component adjacent to a background of the component based on the one or more peaks.

5. The method of claim 4, wherein the one or more edges comprise at least two peaks, the method further comprising determining a reference dimension of the component based on a distance between the two peaks.

6. The method of claim 2, further comprising aligning the one or more peaks corresponding to the one or more regions of interest of the component with a reference geometry in order to perform a datum alignment of the x-ray image.

7. The method of claim 1, wherein applying the contrast agent further comprises infusing the contrast agent into one or more pores of the component.

8. The method of claim 7, wherein applying the contrast agent further comprises lowering a temperature of the component to solidify the contrast agent after infusion.

9. The method of claim 1, wherein applying the contrast agent further comprises coating the one or more regions of interest of the component with the contrast agent.

10. The method of claim 9, wherein the coating process is one of:
direct coating;
chemical vapor deposition;
physical vapor deposition;
electroplating;
electroplating and selective etching; multi-material additive layer manufacturing; and
powder coating.

11. The method of claim 1, wherein the contrast agent comprises mercury, lead, platinum or an alloy thereof.

12. The method of claim 1, wherein the contrast agent comprises a resin embedded with a plurality of nanoparticles.

13. The method of claim 12, wherein applying the contrast agent further comprises:
coating the one or more regions of interest of the component with the resin; and
curing the resin after coating by at least one of lowering a temperature and exposure to light.

14. The method of claim 1, wherein the x-ray image comprises a plurality of voxels, each voxel from the plurality of voxels having a voxel size, wherein a thickness of the contrast agent on the one or more regions of interest of the component is equal to or less than the voxel size.

15. The method of claim 1, wherein the mass attenuation coefficient of the material of the contrast agent is at least twice the mass attenuation coefficient of the material of the component.

16. The method of claim 1, wherein the component is metallic.

17. The method of claim 1, wherein the component is a turbine blade of a gas turbine engine.
